(19) United States
(12) Patent Application Publication
(10) Pub. No.: US 2008/0271573 A1
(43) Pub. Date: Nov. 6, 2008

(54) Ratcheted Cork Screw

(75) Inventors: Aaron Lown, Tuxedo, NY (US); John Roscoe Swartz, Ridgewood, NJ (US); Wilson Kwok, Central (HK); Tugrul Akok, Nanshan (CN); Chen Wai Xing, Dongguan (CN)

Correspondence Address: FISH & RICHARDSON P.C., P.O. BOX 1022, MINNEAPOLIS, MN, 55440-1022, US

(73) Assignee: Built NY

(21) Appl. No.: 12/027,664

(22) Filed: Feb. 7, 2008

Related U.S. Application Data
(60) Provisional application No. 60/888,920, filed on Feb. 8, 2007.

(51) Int. Cl. B67B 7/04; B25B 13/46

(52) U.S. Cl. 81/3.45; 81/60

(57) ABSTRACT

A corkscrew includes a ratcheting feature to facilitate insertion of the bit into a closure and a locking feature to facilitate removal of the bit from the closure. A corkscrew also includes a removable bit (e.g., a worm, auger, or the like).

### CLAIM OF PRIORITY

This application claims priority under 35 USC §119(e) to U.S. Provisional Patent Application Ser. No. 60/888,920, filed on Feb. 8, 2007, the entire contents of which are hereby incorporated by reference.

### TECHNICAL FIELD

This disclosure relates to a ratcheted cork screw and mechanical assemblies.

### BACKGROUND

Containers can be sealed in a variety of ways. One manner is forcing a tightly-fitting closure into the container's aperture. The closure frequently takes the form of a cylindrical cork. Natural cork is prevalent, though substitutes are available as well. Accordingly, the use of the term “cork” in this disclosure will encompass both natural cork and its substitutes.

Containers that utilize corks include, e.g., wine bottles, vinegar bottles, oil bottles and the like. Commonly, the cork is deeply seated within the container and a specialized tool, e.g., a corkscrew, is needed for removal.

The most common way of using a conventional corkscrew consists of three general steps: (1) Insertion: part of the corkscrew (a worm, auger, or the like) is rotated as it is inserted and engages with the cork; (2) Extraction: The worm is drawn away from the bottle, bringing with it the cork; and (3) Cork removal: The cork is removed from the corkscrew.

### SUMMARY

In an aspect of the invention, a corkscrew is provided that includes a removable bit (e.g., a worm, auger, or the like). In another aspect, a corkscrew is provided that includes a ratcheting feature to facilitate insertion of the bit into the closure and a locking feature to facilitate removal of the bit from the closure.

The details of one or more embodiments are set forth in the accompanying drawings and the description below. Various features and advantages will be apparent from the description and drawings, and from the claims.

### BRIEF DESCRIPTION OF DRAWINGS

FIG. 1 is a perspective view of an implementation of a corkscrew.

FIG. 2 is an exploded view of an implementation of a corkscrew.

FIG. 3 is a side view of certain features of an implementation of a corkscrew.

FIG. 4 is a bottom view of certain features of an implementation of a corkscrew.

FIG. 5 is an exploded view of a second implementation of a corkscrew.

### DETAILED DESCRIPTION

The following is a description of some implementations of a corkscrew.

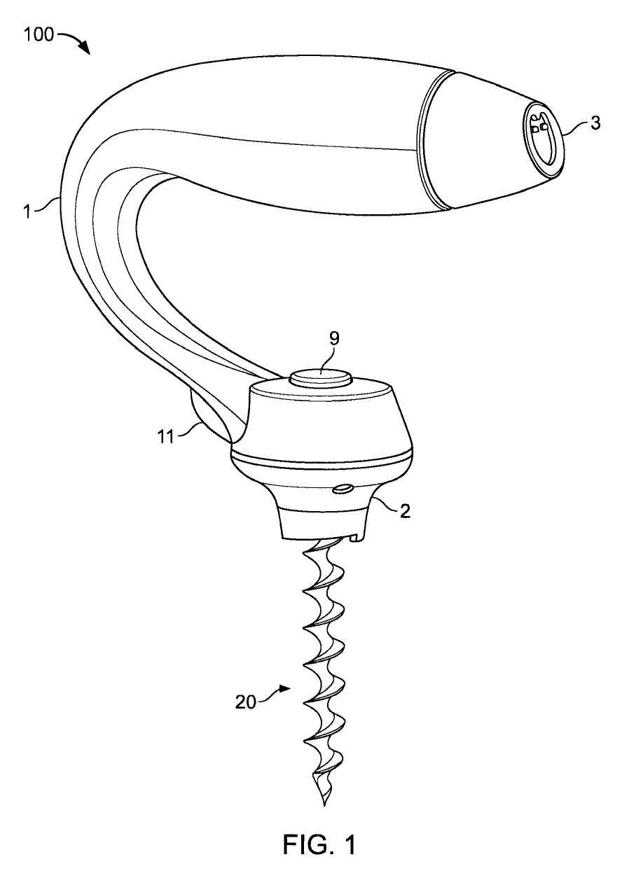

FIG. 1 illustrates a perspective view of an implementation of a corkscrew 100. The major components include the handle 1 and the bit 20. As shown, the handle 1 is shaped in a manner that is comfortable to the hand, and provides leverage to ease insertion of the bit 20 into the cork. Other shapes are possible, and include, e.g., toriodal shapes, spherical shapes, and various other polyhedra and closed surfaces.

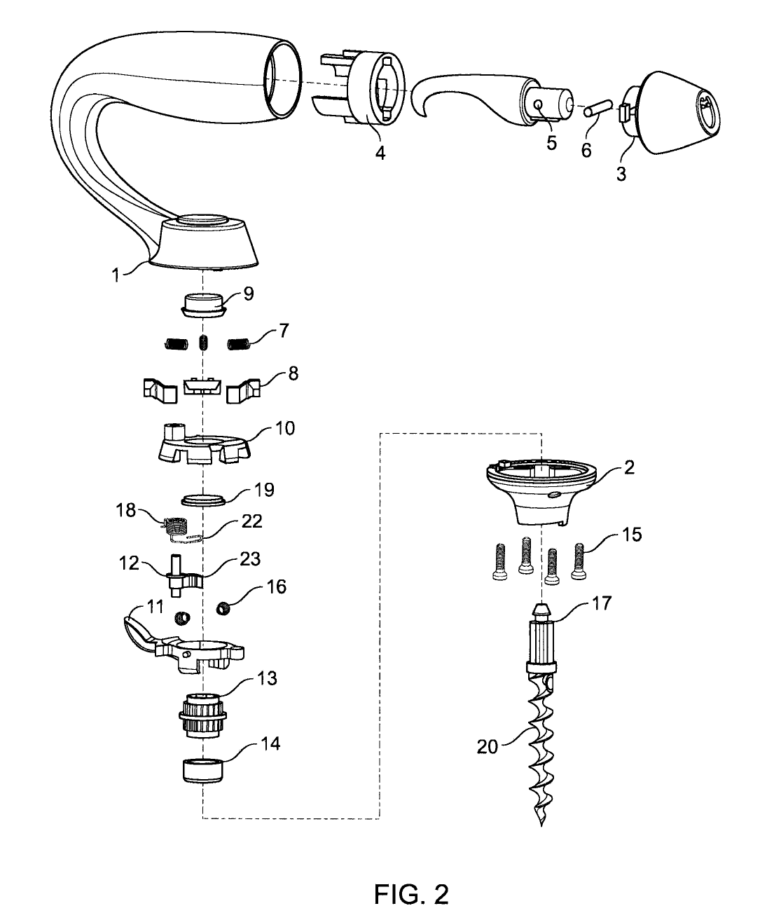

The handle 1 includes a removable cover 3 that is used to access a tool stored within the body of the handle 1. The tool can vary in different implementations, but in a corkscrew directed to opening wine bottles, possibilities include a foil cutter, a drip-resistant spout, or a screen (e.g., for filtering sediment when decanting, pouring, or serving). Also present on the handle is the bit release button 9. Depressing button 9 causes the bit to detach from the handle 20. Details regarding the operation of the bit release button 9 are discussed in greater detail in connection with FIG. 2. Removing the bit 20 allows, inter alia, safe storage of the bit 20 separate from the handle 1 and enables the use of bits that are optimized for the closure that the user desires to remove. For example, the bit 20 can be a variety of different worms or augers for penetrating cork. Such bits are usually made of metal (e.g., an iron-based or aluminum-based alloy or a pure metal) and are sometimes coated with a low-friction layer to ease insertion into a cork. Other designs may use ceramic, plastic, polymer, or composite bits. The bit 20 can come in a variety of lengths to, e.g., avoid penetrating the bottom of the cork. Other bits may be configured to grasp the outside of a cork, e.g., in an application to remove corks from sparkling wine bottles.

The bit 20 is removably connected to a ratcheting mechanism disposed inside the handle 1 and stop cap 2. The details of this mechanism are discussed in greater detail in connection with FIG. 2. For present purposes, the ratcheting mechanism selectively allows free-wheeling rotation of the bit 20 relative to the handle 1 in one direction, while preventing such motion in the other direction.

The handle 1 also includes a gear brake lever 11 (part of the larger gear brake assembly). Engaging the gear brake lever 11 (e.g., by pushing it either to the right or left) prevents any rotation of the bit 20 without also causing rotation of the handle 1. This allows the user, e.g., in the case of an auger or worm bit, to easily remove the cork by rotating the handle and keeping the cork steady (or vice versa).

The handle 1 can be made of a variety of materials. In some applications, plastic can be used. Other applications may use, alone or in combination, one or more metals, ceramics, plastics, or polymers. The handle can be made to be one or more colors for aesthetic or functional reasons, and may be made of a luminescent material (i.e., “glow in the dark” material) to ease location in dark environments often encountered in restaurants or the like. The handle may also include designs, logos, words, etc. for branding, promotional, personalization, or other purposes.

FIG. 2 is an exploded view of an implementation of a corkscrew 100. This view illustrates, inter alia, the components within the handle 1 and stop cap 2. Cover 3 is shown removed from the handle 1, and the tool (foil cutter 5) normally stored therein is shown. Stop bar 6 is normally disposed within the mating hole at the end of the foil cutter 5 nearest the cover 3. The stop bar 6 prevents the foil cutter 5 from traveling past the tool sleeve 4. The cover 3 fastens to the tool sleeve 4, and the tool sleeve is affixed to the handle 1. As mentioned earlier, the tool may take forms other than the foil cutter 5.

Next, the removable bit feature will be discussed. To remove a bit from the corkscrew 100, a user would depress the bit release button 9, which is accessible via a mating hole in the housing 1. In so doing, the chamfered bottom edge of the bit release button 9 engages with the angled walls of the bit retaining jaws 8, which are held in tension by the bit retaining jaw springs 7. Three bit retaining jaws 8 and three bit retaining jaw springs 7 are shown, but other implements may use more or less. Pressing the bit release button 9 therefore forces the bit retaining jaws outward to a diameter larger than the top shaft 17 of the bit 20, thus allowing the bit to be removed. The gear retaining plate 10 holds the bit retaining jaws 8 and bit retaining springs 7 in operational alignment. The bit release button 9 can be made of any of a variety of materials, though a certain degree of stiffness is preferred in some implementations since the chamfered edge displaces the bit retaining jaws 8 against the tension imparted by the bit retaining jaw springs 7. The bit retaining jaws 8, since they retain the bit 20 and may endure substantial stresses during cork removal, are in some implementations preferably made from a relatively stiff, wear-resistant material. For the button 9 and jaws 8, suitable materials include, e.g., metals (aluminum- and iron-based alloys or pure metals), plastics, ceramics, or composites. In some implementations, the springs 7 can be made of a material that provides sufficient resilient force and can endure the cyclic stresses from repeated insertion and removal of bits. Suitable materials include a variety of metals, both alloyed and pure.

A substantial advantage of this removable bit mechanism is that it allows a bit to be removably affixed to the handle, yet able to withstand the substantial tension necessitated to remove a closure (e.g., a cork from a wine bottle). In some implementations, to insert a bit, it is simply slid upward toward the handle 1 and the spring loaded bit retaining jaws 8 lock it in place.

The ratcheting function will now be discussed. The gear retaining plate 10 also serves the purpose of accepting the top shaft of the lock pin 12 in a hole of similar diameter, thereby allowing lock pin 12 to rotate freely. The lock pin spring 18 accepts the top shaft of the lock pin 12 and has a tab 22 that keeps the arm 23 of the lock pin 12 in tension against the ratchet/brake gear 13, thus providing the ratcheting function. In short, the orientation of the arm 23 (which is pressed against the upper half of the ratchet/brake gear 13 by the tab 22) allows it to easily move past the teeth of the ratchet/brake gear 13 in one direction, but prevents movement in the other. This allows the user to drive the bit 20 into the closure (e.g., a cork) without having to make complete revolutions of the handle. One advantage is that this will decrease the time and effort needed in the insertion step. Note that the gear retaining plate 10 does not rotate relative to the handle 1. Also, note that a portion of the cross-section of the upper portion of the shaft 17 passes through and matches an opening (13a) in the center of the ratchet/break gear 13. This ensures that the bit 20 and ratchet/break gear 13 always co-rotate.

Next, the braking feature will be discussed. As mentioned, the ratchet/brake gear 13 is divided into an upper half and a lower half. The upper half has teeth going in a counter clockwise direction and functions as the gear for the ratcheting mechanism (discussed above). The lower half has teeth going in a clockwise direction and functions as the gear for the for the brake mechanism. The teeth on the lower half of the 10 ratchet/brake gear 13 are configured to engage the teeth in gear brake 11 when the lever on the gear brake 11 is pushed either left or right. When in the center position, the teeth on the gear brake 11 do not engage the ratchet/brake gear 13 at all. Gear brake springs 16 keep the gear brake 11 biased in the center position. The clockwise direction of the teeth on the lower half of the ratchet/brake gear 13 are designed to go in the opposite direction of the teeth on the upper half of the ratchet/brake gear 13 to maximize the braking force when the gear brake lever 11 is fully pressed by the user. As a result, when the brake is applied, the bit 20 cannot rotate in any direction without also causing the handle 1 to rotate. By holding the handle 1 steady, this enables, e.g., easy removal of the closure from the bit (for example, removing a cork from an auger or worm). The gear brake 11, in some implementations, is preferably made of a hard material. One possible material is powder forged steel, but other options include ceramics, plastics, and other metals (both alloyed and pure).

With reference to FIG. 2, on the rightmost end of the gear brake 11 there is a flange with a hole bored out of it. This flange accepts a pin (not shown) that is molded into the cavity in the handle 1 and is the pivot point about which the gear brake 11 rotates.

Upper and lower bushings 19 and 14 enable smooth rotation of the ratchet/gear brake 13, and in some implementations can be made from self lubricating material such as polyoxymethylene (e.g., available as Delrin® from E.I. du Pont de Nemours and Company) or polytetrafluoroethylene (e.g., available as Teflon® from E.I. du Pont de Nemours and Company).

Stop cap 2 forms a housing for some of the foregoing components, and maintains them in operational alignment. Screws 15 pass through the stop cap 2 and attach to the handle 1 to secure the foregoing components within the handle 1 and stop cap 2.

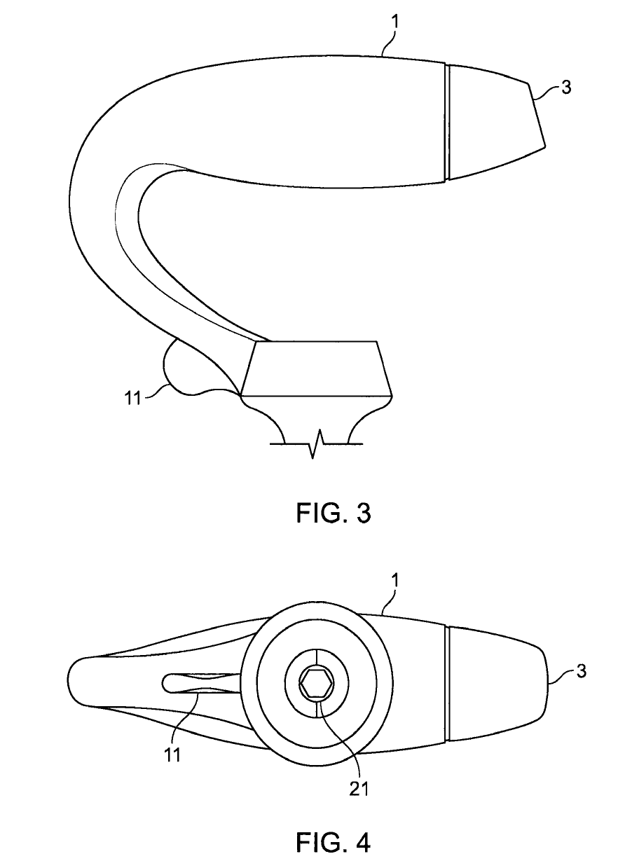

FIG. 3 is a side view of the handle 1. Shown is cover 3 and gear brake lever 11. FIG. 4 is a bottom view of the handle 1. Bit chuck 21 is visible from this perspective and accommodates the cross section of a bit 20. While various cross sections are possible, non-circular ones are preferred to maximize efficiency of torque delivery. In this illustration, a hexagonal cross section has been implemented.

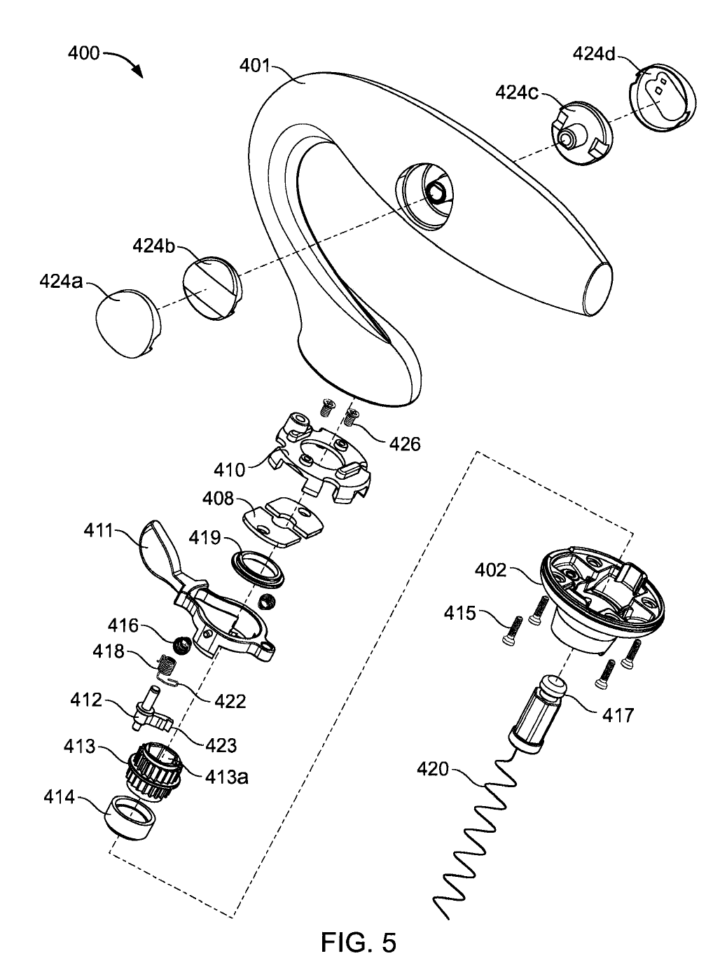

FIG. 5 is an exploded view of a second implementation of a corkscrew 400. In this implementation, the bit 420 is not removable. Accordingly, it is possible to manufacture this implementation at a lower cost than the implementation of FIG. 2. Aside from the bit 420 being non-removable, the construction and functionality is substantially the same as the implementation of FIG. 2.

This view illustrates, inter alia, the components within the handle 401 and stop cap 402. For branding purposes, a logo assembly 424a-424d allows placement of a logo or other identifier (imprinted on parts 424a and/or 424d) on the handle 401.

In this implementation, the bit 420 is not removable. When assembled, plates 408 engage the top shaft 417 of the bit 420. The plates 408 are fixed to gear retaining plate 410 via screws 426. Thus, the plates 408 capture the bit 420 in place. The gear retaining plate 10 maintains various aspects of the assembly in operational alignment.

The ratcheting function will now be discussed. The gear retaining plate 410 also serves the purpose of accepting the top shaft of the lock pin 412 in a hole of similar diameter, thereby allowing lock pin 412 to rotate freely. The lock pin spring 418 accepts the top shaft of the lock pin 412 and has a tab 422 that keeps the arm 423 of the lock pin 412 in tension against the ratchet/brake gear 413, thus providing the ratcheting function. In short, the orientation of the arm 423 (which is pressed against the upper half of the ratchet/brake gear 413 by the tab 422) allows it to easily move past the teeth of the ratchet/brake gear 413 in one direction, but prevents movement in the other. This allows the user to drive the bit 420 into the closure (e.g., a cork) without having to make complete revolutions of the handle. One advantage is that this will decrease the time and effort needed in the insertion step. Note that the gear retaining plate 410 does not rotate relative to the handle 401. Also, note that a portion of the cross-section of the upper portion of the shaft 417 passes through and matches an opening (413a) in the center of the ratchet/break gear 413. This ensures that the bit 420 and ratchet/break gear 413 always co-rotate.

Next, the braking feature will be discussed. As mentioned, the ratchet/brake gear 413 is divided into an upper half and a lower half. The upper half has teeth going in a counter clockwise direction and functions as the gear for the ratcheting mechanism (discussed above). The lower half has teeth going in a clockwise direction and functions as the gear for the for the brake mechanism. The teeth on the lower half of the ratchet/brake gear 413 are configured to engage the teeth in gear brake 411 when the lever on the gear brake 411 is pushed either left or right. When in the center position, the teeth on the gear brake 411 do not engage the ratchet/brake gear 413 at all. Gear brake springs 416 keep the gear brake 411 biased in the center position. The clockwise direction of the teeth on the lower half of the ratchet/brake gear 413 are designed to go in the opposite direction of the teeth on the upper half of the ratchet/brake gear 413 to maximize the braking force when the gear brake lever 411 is fully pressed by the user. As a result, when the brake is applied, the bit 420 cannot rotate in any direction without also causing the handle 401 to rotate. By holding the handle 401 steady, this enables, e.g., easy removal of the closure from the bit (for example, removing a cork from an auger or worm). The gear brake 411, in some implementations, is preferably made of a hard material. One possible material is powder forged steel, but other options include ceramics, plastics, and other metals (both alloyed and pure).

With reference to FIG. 4, on the rightmost end of the gear brake 411 there is a flange with a hole bored out of it. This flange accepts a pin (not shown) that is molded into the cavity in the handle 401 and is the pivot point about which the gear brake 411 rotates.

Upper and lower bushings 419 and 414 enable smooth rotation of the ratchet/gear brake 413, and in some implementations can be made from self lubricating material such as polyoxymethylene (e.g., available as Delrin® from E.I. du Pont de Nemours and Company) or polytetrafluoroethylene (e.g., available as Teflon® from E.I. du Pont de Nemours and Company).

Stop cap 402 forms a housing for some of the foregoing components, and maintains them in operational alignment. Screws 415 pass through the stop cap 402 and attach to the handle 401 to secure the foregoing components within the handle 401 and stop cap 402.

A number of implementations of the invention have been described. Nevertheless, it will be understood that various modifications may be made without departing from the spirit and scope of the invention, For example, a variety of different bit types, handles, tools, and materials are possible. Accordingly, other embodiments are within the scope of the following claims.

What is claimed is:

1. A corkscrew comprising:
a handle;
a ratcheting mechanism disposed in the handle;
a chuck to receive a bit, the chuck disposed in the handle and coupled to the ratcheting mechanism;
a removable bit mechanism disposed in the handle and coupled to the chuck, the removable bit mechanism comprising: spring loaded jaws biased in a first position; and a release mechanism to spread the spring loaded jaws to a second position, the release mechanism comprising an actuator disposed on an outside surface of the handle; and
a locking mechanism disposed in the handle and coupled to the chuck to selectively prevent rotation of the bit.

2. The corkscrew of claim 1 wherein the ratcheting mechanism comprises:
a ratchet gear comprising a first row of teeth;
a tab spring-biased against the first row of teeth.

3. The corkscrew of claim 1 wherein the chuck comprises a non-circular cross section.

4. The corkscrew of claim 1 wherein the removable bit mechanism maintains the bit within the chuck despite tension applied to the bit.

5. The corkscrew of claim 1 wherein the actuator is a button.

6. The corkscrew of claim 5 wherein the button has a chamfered bottom that presses against the spring loaded jaws, thereby spreading the spring loaded jaws.

7. The corkscrew of claim 1 wherein the bit is an auger or a worm.

8. The corkscrew of claim 1 wherein the bit engages the outside of cork.

9. The corkscrew of claim 1 wherein the bit is adapted to remove the cork from a bottle of sparkling wine.

10. The corkscrew of claim 2 wherein the locking mechanism comprises:
a lock gear comprising a second row of teeth, the lock gear coupled to the ratchet gear; and
a gear brake member movable between a locking position and a non-locking position;
wherein in the locking position, the gear brake engages with the second row of teeth and prevents rotation of the bit relative to the handle.

11. The corkscrew of claim 10 wherein the lock gear and ratchet gear are formed as a single assembly.

12. A corkscrew comprising:
a handle;
a bit;
a ratcheting mechanism disposed in the handle and coupled to the bit; and
a bit capture mechanism to non-removably receive the bit, the bit capture mechanism disposed in the handle and coupled to the ratcheting mechanism.

13. The corkscrew of claim 12 comprising a locking mechanism disposed in the handle and coupled to the ratcheting mechanism for selectively preventing rotation of the bit relative to the handle.

14. The corkscrew of claim 12 wherein the ratcheting mechanism comprises:
a ratchet gear comprising a first row of teeth;
a tab spring-biased against the first row of teeth.

15. The corkscrew of claim 12 wherein the bit capture mechanism comprises a pair of opposing plates that couple to the bit.

16. The corkscrew of claim 12 wherein the bit is an auger or a worm.

17. The corkscrew of claim 14 wherein the locking mechanism comprises:
a lock gear comprising a second row of teeth, the lock gear coupled to the ratchet gear; and
a gear brake member movable between a locking position and a non-locking position;
wherein in the locking position, the gear brake engages with the second row of teeth and prevents rotation of the bit.

18. The corkscrew of claim 17 wherein the lock gear and ratchet gear are formed as a single assembly.

19. A corkscrew comprising:
a handle;
a bit;
ratchet means coupled to the bit for selectively allowing rotation of the bit in a first direction and preventing rotation of the bit in a second direction; and
means for non-removably receiving the bit, the means for non-removably receiving the bit coupled to the ratchet means.

20. The corkscrew of claim 12 comprising locking means for selectively preventing rotation of the bit in both the first and the second directions.
